(19) United States
(12) Patent Application Publication
(10) Pub. No.: US 2025/0284053 A1
(43) Pub. Date: Sep. 11, 2025

(54) THIN FILM LITHIUM CONTAINING MODULATOR ARRAY USING SHORT WAVELENGTHS

(71) Applicant: HyperLight Corporation, Cambridge, MA (US)

(72) Inventors: Mian Zhang, Cambridge, MA (US); Christian Reimer, Wellesley, MA (US)

(21) Appl. No.: 19/064,628

(22) Filed: Feb. 26, 2025

Related U.S. Application Data
(60) Provisional application No. 63/559,752, filed on Feb. 29, 2024.

(51) Int. Cl. G02B 6/122; G02B 6/12; G02B 6/13

(52) U.S. Cl. CPC G02B 6/122; G02B 6/12004; G02B 6/13; G02B 2006/1204; G02B 2006/12142

(57) ABSTRACT

A photonics device is described. The photonics device includes a waveguide and an electrode. The waveguide configured to transmit an optical signal having a wavelength less than 1100 nanometers and is a single mode waveguide. The waveguide includes electro-optic material(s). The electrode is proximate to a portion of the waveguide and configured to carry an electrode signal for modulating the optical signal. The photonics device is configured to be coupled with at least one multimode fiber. The multimode fiber(s) is configured to transmit a plurality of modes.

### CROSS REFERENCE TO OTHER APPLICATIONS

This application claims priority to U.S. Provisional Patent Application No. 63/559,752 entitled THIN FILM LITHIUM CONTAINING MODULATOR ARRAY USING SHORT WAVELENGTHS filed Feb. 29, 2024 which is incorporated herein by reference for all purposes.

### BACKGROUND OF THE INVENTION

Optical communication is utilized in both short range computing applications and long range telecommunication applications. Some longer range communication applications typically use single mode fibers that carry optical signals over lengths that may range from at least 500 meters to not more than two kilometers. For example, a single mode fiber might carry an optical signal including a TEO mode of an operating wavelength of 1310 nanometers. Modulation of the optical signal allows the 1310 nanometer light to carry data and is typically carried out by a single mode modulator. Such a single mode modulator includes a waveguide configured to carry a single mode (e.g. the TEO mode) and electrodes that are driven by driver electronics. The modulated signal is provided to the single mode fiber. Because of the low dispersion of the single mode fiber, the optical signal may be carried for longer distances (e.g. five hundred meters to two kilometers for optical signals having a wavelength of 1310 nanometers) before being regenerated. For telecommunications applications, optical signals having a wavelength of 1550 nanometers may be used. Such single mode optical signals may travel for much longer distances in single mode optical fibers before regeneration. However, the single mode modulator and single mode optical fibers combinations are generally expensive and have high power consumption.

In contrast, short range computing applications typically use multi-mode optics for encoding and transmitting optical signals. Multi-mode optical fibers transmit the optical signals. Multi-mode optical fibers have a larger diameter (e.g., fifty micrometers) and are capable of carrying multiple optical modes. For example, both TE modes and TM modes might be propagated through a particular multi-mode fiber. Typically, the optical signals for data communications use operating wavelengths near 850 nanometers (e.g. 840 nm-900 nm). The optical signals may be generated by a modulated laser, such as a vertical cavity surface emitting laser (VCSEL). A VCSEL emits multiple modes. In order to provide data signals, the VCSEL is modulated. For example, the power input to the VCSEL may be modulated. The output of the VCSEL is coupled to a multi-mode fiber. Such a multi-mode solution is typically used for short range data communication (e.g. data communication over fiber lengths not exceeding ten meters). However, it is very difficult to modulate the VCSEL at high frequencies (e.g. for a 100 Gb per second per lane or more). This limitation is due to the VCSEL electro-optic bandwidth limit, which is dictated by carrier dynamics within the laser cavity. Further, the inter-modal dispersion combined with the limited speed of the VCSEL modulation at 850 nanometer wavelengths may limit not only the length of transmission, but also the bandwidth. Accordingly, improvements to optical communications, particularly for data communications, are desired.

### BRIEF DESCRIPTION OF THE DRAWINGS

Various embodiments of the invention are disclosed in the following detailed description and the accompanying drawings.

FIGS. 1A-1B depict an embodiment of a photonics device capable of utilizing optical signals having shorter wavelengths and that is usable with multimode fibers.

FIGS. 2A-2C depict embodiments of photonics devices capable of using shorter wavelengths and that are usable with multimode fibers.

FIGS. 3A-3B depict an embodiment of photonics devices capable of using shorter wavelengths and that are usable with multimode fibers.

FIGS. 4A-4B depict embodiments of photonics devices capable of using shorter

wavelengths and that are usable with multimode fibers.

FIG. 5 is a flow chart depicting an embodiment of a method for providing a photonics device capable of using shorter wavelengths and that is usable with multimode fibers.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

High speed and energy efficient interfaces are desired for next generation computing and network input/output (I/O). As a result, optical communications are of increasing interest for data communication applications. Currently, multi-mode optical fibers are used to transmit optical signals generated by modulated vertical surface emitting lasers (VCSELs). Multi-mode fibers typically have a large diameter (e.g. on the order of fifty micrometers or more) and utilize wavelengths in the 840-990 nanometer range. However, the multi-mode fibers exhibit modal dispersion. Moreover, modulating VCSELs at high frequencies (e.g. for 100 Gb per second per lane or more) is extremely challenging. Consequently, other techniques for optical data communication are desired.

A photonics device is described. The photonics device includes a waveguide and an electrode. The waveguide configured to transmit an optical signal having a wavelength less than 1100 nanometers and is a single mode waveguide. In some embodiments, the optical signal has a wavelength not exceeding 1000 nanometers (e.g. 980 nanometers, 950 nanometers, and/or 850 nanometers) and at least 100 nanometers. The waveguide includes electro-optic material(s). The electrode is proximate to a portion of the waveguide and configured to carry an electrode signal for modulating the optical signal. The electrode signal through the electrodes has a desired frequency (e.g. having a frequency of at least 50 GHz, at least 100 GHz, at least 130 GHz, or up to 500 GHz or more in some embodiments) and a desired bandwidth (e.g. a frequency window of at least 10 GHz). The photonics device is configured to be coupled with at least one multimode fiber. Each of the multimode fiber(s) is configured transmit to a plurality of modes.

In some embodiments, the electrode is driven by a data signal received at the photonics device. In some embodiments, the electrode is driven by a driver, such as a digital signal processor, or a custom driver. The electro-optic material may include lithium. For example, the electro-optic material may include lithium niobate and/or lithium tantalate. The photonics device may also include an additional electrode proximate to the portion of the waveguide. The portion of the waveguide is between the additional electrode and the electrode, the electrode and the additional electrode being separated by a distance of not more than three micrometers proximate to the portion of the waveguide.

The photonics device may also include a fiber array unit (FAU). The FAU is configured to be coupled with the multimode fiber(s). In some embodiments, the optical signal includes light having the wavelength received from a vertical cavity surface emitting laser (VCSEL). In some embodiments, the VCSEL does not modulate the light, but the photonics device does. In some embodiments, both the VCSEL and the photonics device may modulate the light. In some embodiments, the photonics device also includes a multi-mode receive that may be coupled to a multi-mode fiber. In such embodiments, the single mode modulator and electrode(s) may operate as a transmitter. The portion of the waveguide proximate to the electrode(s) may have a length of not more than one centimeter, an electro-optic bandwidth of at least 100 GHz, and an input voltage for the electrode of not more than 2 V.

A photonics device including an optical transmitter and a receiver is described. The optical transmitted includes waveguides and electrodes. The waveguides are configured to transmit optical signals and are single mode waveguides. The waveguides including at least one electro-optic material. A waveguide of the waveguides carries an optical signal of the optical signals. The optical signal has a wavelength less than 1100 nanometers. A portion of the electrodes is proximate to a portion of the waveguides. The electrodes are configured to carry electrode signals for modulating the optical signals. The receiver is configured to received input optical signals. The photonics device is configured to be coupled with multimode fiber(s). Each of the multimode fibers being configured to carry multiple modes.

In some embodiments, the electrodes are driven by data signals received at the photonics device. In some embodiments, the electrodes are driven by driver(s). In some embodiments, the electro-optic material includes lithium. The electrodes may include first and second electrodes. The portion of a waveguide is between the first and second electrodes. In some such embodiments, the first electrode and the second electrode being separated by a distance of not more than three micrometers proximate to the portion of the waveguide. The photonics device may also include a fiber array unit configured to be coupled with the multimode fibers. In some embodiments, the optical signals include light received from a VCSEL. In some embodiments, the photonics device includes an interposer configured to couple the receiver, the transmitter, and an electronics integrated circuit. In some embodiments, the portion of each waveguide proximate to the portion of the electrodes has a length of not more than one centimeter, an electro-optic bandwidth of at least 100 GHz, and an input voltage for the electrode of not more than 2 V.

A method for providing a photonics device is described. The method includes providing a waveguide configured to transmit an optical signal having a wavelength less than 1100 nanometers. The waveguide is a single mode waveguide and includes at least one electro-optic material. The method also includes providing an electrode proximate to a portion of the waveguide and configured to carry an electrode signal for modulating the optical signal. The photonics device is configured to be coupled with at least one multimode fiber that is configured to a plurality of modes. The electro-optic material may include lithium. In some embodiments, providing the electrodes also includes providing an additional electrode proximate to the portion of the waveguide. The portion of the waveguide is between the additional electrode and the electrode. The electrode and the additional electrode are separated by a distance of not more than three micrometers proximate to the portion of the waveguide. The portion of the waveguide proximate to the electrodes may have a length of not more than one centimeter, an electro-optic bandwidth of at least 100 GHz, and an input voltage for the electrode of not more than 2 V.

Various features of the optical (e.g. photonic) devices are described herein. One or more of these features may be combined in manners not explicitly described herein. In addition, only portions of the optical devices are shown. Further, although an input is indicated in the drawings and/or described in the text, in some embodiments, signals may be reversed such that the input functions as an output.

The optical devices described herein may be formed using electro-optic materials, such as thin film lithium containing (TFLC) electro-optical materials. For example, thin film lithium niobate (TFLN) and/or thin film lithium tantalate (TFLT) may be used for the components described. Although primarily described in the context of TFLC electro-optic materials, such as TFLN and TFLT, other nonlinear optical materials may be used in the optical devices described herein. For example, other ferroelectric nonlinear (e.g. second order) optical materials may also be desired to be used in, e.g., waveguides. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguides described herein are low optical loss waveguides. For example, a waveguide may have a total optical loss of not more than 10 dB through the portion of waveguide (e.g. when biased at maximum transmission and as a maximum loss) in proximity to electrodes used in modulating the optical signal. The total optical loss is the optical loss in a waveguide through a single continuous electrode region (e.g. as opposed to multiple devices cascaded together). In some embodiments, the waveguide has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, the waveguide has an optical loss of not more than 3 dB/cm (e.g. on average). In some embodiments, the nonlinear material(s) in the waveguides has an optical loss of not more than 2.0 dB/cm. In some such embodiments, the waveguide has an optical loss of not more than 1.0 dB/cm. In some embodiments, the waveguide has an optical loss of not more than 0.5 dB/cm. In some embodiments, the low optical losses are associated with a low surface roughness of the side walls of the waveguides.

The waveguides may have improved surface roughness. For example, the short range root mean square surface roughness of a sidewall of the ridge may be less than ten nanometers. In some embodiments, this root mean square surface roughness is not more than five nanometers. In some cases, the short range root mean square surface roughness does not exceed two nanometers. In some embodiments, a waveguide includes a ridge portion and a slab portion. The height of such a ridge portion is selected to provide a confinement of the optical mode such that there is a 10 dB reduction in intensity from the intensity at the center of the ridge at ten micrometers from the center of the ridge. For example, the height of the ridge is on the order of a few hundred nanometers in some cases. However, other heights are possible in other embodiments. Various other optical components may be incorporated into the waveguide to provide the desired functionality. For example, the waveguide may have wider portion(s) for accommodating multiple modes or performing other functions.

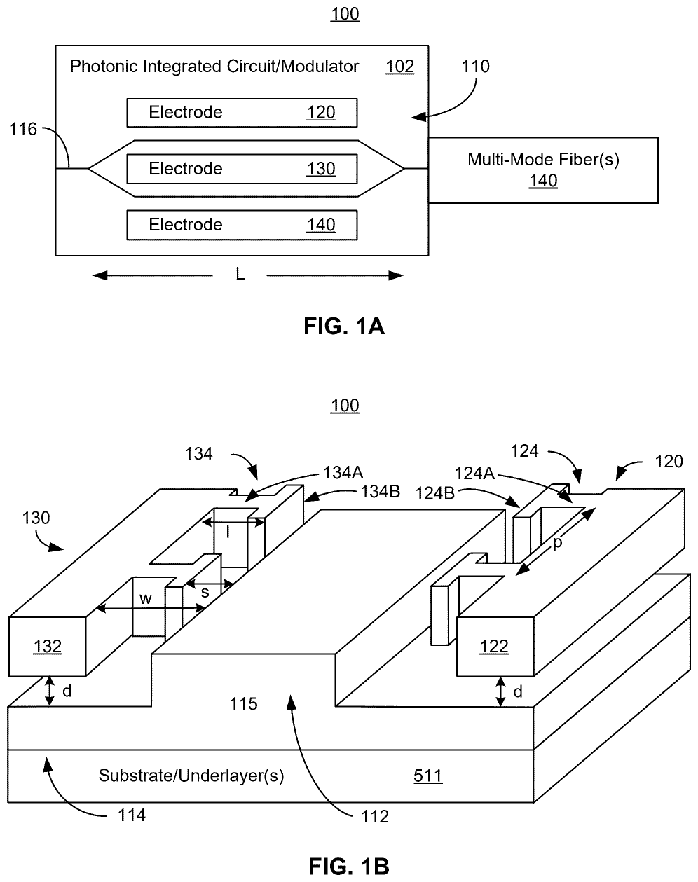

FIGS. 1A-1B depict an embodiment of photonics device 100 capable of utilizing optical signals having shorter wavelengths and that is usable with multimode fibers. FIG. 1A depicts a block diagram of photonics device 100, while FIG. 1B depicts a perspective view of a portion of photonics device 100. For clarity, not all components are shown. In addition, FIGS. 1A and 1B are not to scale.

Referring to FIG. 1A, photonics device 100 includes a photonic integrated circuit (PIC) 102 including optical modulator 110 and that may be coupled with one or more multi-mode optical fibers 140. For example, multi-mode fiber(s) may be a multi-mode fiber or a multi-mode fiber array/bundle. Optical modulator 110 includes waveguide 116 and electrodes 120, 130, and 135. Thus, a Mach-Zehnder configuration of optical modulator 110 is shown. Other configurations (e.g. phase and/or amplitude) are possible. Waveguide 116 is configured to transmit an optical signal having a wavelength less than 1100 nanometers. In some embodiments, the optical signal has a wavelength not exceeding 1000 nanometers (e.g. 980 nanometers, 950 nanometers, and/or 850 nanometers) and at least 100 nanometers. For example, waveguide 116 may include or consist of thin film lithium-containing (TFLC) materials such as thin film lithium niobate (TFLN) and/or thin film lithium tantalate (TFLT), which transmit light in this wavelength range (e.g. 800 nanometers through one thousand one hundred nanometers). Stated differently, waveguide 116 may be transparent to light (i.e. can carry optical signals having wavelengths) in this wavelength range. Thus, waveguide 116 is not formed of silicon, which is opaque in this range of wavelengths.

In some embodiments, the TFLC layer from which waveguide 116 is formed is not more than one micrometer in thickness as-provided (prior to etch(es) forming waveguide 116). In some embodiments, the thickness is not more than 800 as-provided. In some embodiments, the TFLC layer is not more than 600 nm as-provided. Waveguide 116 may have a thickness of at least 50 nanometers and not more than 200 nm proximate to electrodes 120, 130, and 135. Other thicknesses are possible.

Electrodes 120, 130, and 135 are configured to carry electrode signal(s) for modulating the optical signal via the electro-optic effect. For example, electrode 130 may carry an electrode signal in the microwave range, while electrodes 120 and 135 are ground. In some embodiments, electrodes 120 and 135 may carry electrodes signals of one polarity, while electrode 130 carries an electrode signal of another (e.g., opposite) polarity. Other electrode configurations are possible. The electrode signal through electrode(s) 120, 130 and/or 135 has a desired frequency (e.g. having a frequency of at least 50 GHz, at least 100 GHz, at least 130 GHz, or up to 500 GHz or more in some embodiments) and a desired bandwidth (e.g. a frequency window of at least 10 GHz). Waveguide 116 includes electro-optic material(s), allowing for modulation of an optical signal carried by waveguide 116 via the electro-optic effect. The portion of electrodes 120, 130, and 135 shown is proximate to a portion of waveguide 116. Remaining portions of electrodes 120, 130, and 135 are not shown for clarity.

Modulator 110 may be configured to be a single-mode modulator. For example, waveguide 116 may be configured as a single mode waveguide and electrodes 120, 130, and 135 may be configured to modulate a single mode. For example, the width of waveguide 116 may be sufficiently small that a single mode, such as TEO, is supported in a modulation region proximate to electrode 120, 130, and 135. The microwave electrode signal(s) carried by electrode(s) 120, 130, and/or 135 may also be configured to modulate a single mode. However, PIC 102 is configured to be coupled with at least one multimode fiber 140. The output of waveguide 116 may be edge or vertically coupled to multi-mode fiber(s) 140. Each of multimode fiber(s) 140 is configured transmit to a plurality of modes. Thus, multi-mode fiber(s) 140 have a larger diameter than single mode optical fibers. For example, multi-mode optical fiber 140 may have a diameter of at least forty micrometers and not more than sixty micrometers (e.g. nominally fifty micrometers).

In some embodiments, electrodes 120, 130, and/or 135 are driven by a data signal received at PIC 102. In some embodiments, single mode optical modulator 110 is coupled with an integrated circuit that provides this data signal. For example, the data signal received at PIC 102 may drive electrode(s) 130 and/or 130. Thus, a driverless optical modulator may be provided. This may be possible because the V-pi, optical losses, and/or microwave losses are sufficiently low. In some embodiments, the data signal is provided to a driver, such as a digital signal processor, or a custom driver. The driver provides the electrode signal(s) for electrodes 120, 130, and/or 135. The data signal is used to provide the electrical signal through electrodes 120, 130, and/or 135 at the desired rate (e.g. capable of having a frequency of at least 50 GHz, at least 100 GHz, at least 130 GHz, or up to 500 GHz in some embodiments). Thus, photonic device 110 may provide signals carrying at least 100 giga baud, at least 200 giga baud, at least 300 giga baud.

In the region shown, electrodes 120, 130, and/or 135 are separated by a distance that is sufficiently small to provide the desired modulation of the optical signal. The separation distance between electrodes 120, 130, and/or 135 is also sufficiently large that undue losses due to the proximity between electrodes 120, 130, and/or 135 and waveguide 116 may be reduced or avoided. In some embodiments, this distance is less than five micrometers. In some embodiments, this distance is not more than three micrometers. The separation between electrodes 120, 130, and/or 135 may be less than two micrometers in some embodiments. In some such embodiments, the distance between electrodes 120, 130, and/or 135 may be less than one micrometer. Such reduced distances may be facilitated by the shorter wavelengths propagated through waveguide 116.

For optical modulator 110 configured for the wavelength ranges described (e.g. at least 800 nanometers and not more than one thousand or one thousand one hundred nanometers), length of the modulator, L, may be shorter. For example, L may be less than 15 millimeters. In some embodiments, the length of optical modulator 110 is less than 12 millimeters or less than 10 millimeters. In some embodiments, the length of modulator 110 is less than 7 millimeters or less than 5 mm. In some embodiments, L may be less than 3 millimeters and/or less than 2 millimeters.

FIG. 1B depicts a perspective view of a portion of photonics device 100. For clarity, FIGS. 1A and 1B are not to scale and not all components are shown. System 100 includes an electro-optic device 110 and underlying substrate/underlayers 111. Electro-optic device 110 includes TFLC waveguide 116 and electrodes 120 and 130. Elcetrodes 120 and 130 are configured to carry a traveling wave (e.g. a microwave or RF electrode signal) that modulates the optical signal carried by waveguide 116 via the electro-optic effect.

FIG. 1B depicts an embodiment of a portion of electro-optic modulator 110 including TFLC materials. For clarity, top cladding layer(s) are not shown. Such cladding layer(s) would cover the portions of the device depicted. Further, electro-optic device 110 may be configured differently in other embodiments. Electro-optic device 110 includes a substrate and/or underlayers 111, TFLC waveguide 116 that includes ridge waveguide 112 and slab portion 114, and electrodes 120 and 130. Electrode 120 includes channel region 122 and extensions 124. Electrode 130 includes channel region 132 and extensions 134. In some embodiments, extensions 124 and 134 may be omitted. Substrate 111 may include an underlying substrate such as Si and a BOX layer (not separately shown) in FIGS. 1A-5B.

Electro-optic waveguide 116 is or includes a TFLC layer that may include or consist of LN and/or LT. In some embodiments, the nonlinear optical material for TFLC waveguide 116 is formed from a thin film layer. For example, the thin film may have a total thickness (e.g. of thin film or slab portion 114 and ridge waveguide portion 112) of not more than three multiplied by the optical wavelengths for the optical signal carried in waveguide 112 before processing. In some embodiments, the thin film has a total thickness of not more than two multiplied by the optical wavelengths. In some embodiments, the nonlinear optical material has a total thickness of not more than one multiplied by the optical wavelength. In some embodiments, the nonlinear optical material has a total thickness of not more than 0.5 multiplied by the optical wavelengths. For example, the thin film may have a total thickness of not more than three micrometers as-deposited. In some embodiment, the thin film has a total thickness of not more than two micrometers. In some embodiment, the thin film has a total thickness of not more than one micrometer. In some embodiments, the thin film has a total thickness of not more than seven hundred nanometers. In some such embodiments, the thin film has a total thickness of not more than four hundred nanometers. In some embodiments, the thin film has a thickness of at least one hundred nanometers.

The thin film nonlinear optical material may be fabricated into waveguide 116 utilizing photolithography. For example, ultraviolet (UV) and/or deep ultraviolet (DUV) photolithography may be used to pattern masks for the nonlinear optical material. For DUV photolithography, the wavelength of light used is typically less than two hundred and fifty nanometers. To fabricate the waveguide, the thin film nonlinear optical material may undergo a physical etch, for example using dry etching, reactive ion etching (RIE), inductively coupled plasma RIE. In some embodiments, a chemical etch and/or electron beam etch may be used. Waveguide 112 may thus have improved surface roughness. For example, the sidewall(s) of ridge 112 may have reduced surface roughness. For example, the short range root mean square surface roughness of a sidewall of the ridge 112 is less than ten nanometers. In some embodiments, this root mean square surface roughness is not more than five nanometers. In some cases, the short range root mean square surface roughness does not exceed two nanometers. In some embodiments, optical device 110B has an optical loss in signal through the modulator of not more than 1 dB/cm. In some embodiments, the optical loss is not more than 2 dB/cm. In some such embodiments, the optical loss for TFLC waveguide 116 is less than 1.0 dB/cm. For example, this loss may be not more than 0.5 dB/cm in some embodiments. In some embodiments, the height of ridge waveguide 112 is selected to provide a confinement of the optical mode such that there is a 10 dB reduction in intensity from the intensity at the center of ridge waveguide 112 at ten micrometers from the center of ridge waveguide 112. For example, the height of ridge waveguide 112 is on the order of a few hundred nanometers in some cases. The height of ridge waveguide 112 may be not more than three hundred nanometers. In some embodiments, the height of ridge waveguide 112 is not more than two hundred nanometers. In some embodiments, the height of ridge waveguide 112 is not more than one hundred nanometers. However, other heights are possible in other embodiments. A portion of waveguide 112 is proximate to electrodes 120 and 130 along the direction of transmission of the optical signal (e.g. from the input of the optical signal through waveguide 112 to the modulated optical signal output). The portion of waveguide 112 proximate to electrodes 120 and 130 may be the lengths described above, for example a length greater than two millimeters in some embodiments, and greater than two or more centimeters in some such embodiments. Such lengths are possible at least in part because of the low optical losses per unit length for waveguide 112 described herein. Further, the portion of waveguide 112 proximate to electrodes 120 and 130 has an optical mode cross-sectional area that is small, for example not extending significantly beyond the edges of ridge waveguide 112. In some embodiments, ridge waveguide 112 has an optical mode cross-sectional area of less than the square of the wavelength of the optical signal in the nonlinear optical material(s) (e.g. 2). In some embodiments, the optical mode cross-sectional area is less than 3 multiplied by 22, where 2 is the wavelength of the optical signal in the waveguide.

Electrodes 120 and 130 apply electric fields to waveguide 112. Electrode(s) 120 and/or 130 may be fabricated using deposition techniques, such as electroplating, and photolithography to shape the electrode(s) 120 and/or 130. The resulting electrode(s) 120 and/or 130 may have a lower frequency dependent electrode loss, in the ranges described herein. Electrode 120 includes a channel region 122 and extensions 124 (of which only one is labeled in FIG. 1B). Electrode 130 includes a channel region 132 and extensions 134 (of which only one is labeled in FIG. 1B). In some embodiments, extensions 124 or 134 may be omitted from electrode 120 or electrode 130, respectively. Extensions 124 and 134 are closer to waveguide 112 than channel region 122 and 132, respectively, are. For example, the distance s from extensions 124 and 134 to waveguide ridge 112 is less than the distance w from channels 122 and 132 to waveguide ridge 112. In the embodiment shown in FIG. 1B, extensions 124 and 134 are at substantially the same level as channel regions 122 and 132, respectively. In some embodiments, the extensions may protrude above and/or below the channel regions in addition to or in lieu of being at the same level. Further, if electrodes 120 and 130 are above ridge waveguide 112, extensions 124 and 134 may extend over the top of ridge waveguide 112. Stated differently, extensions 124 and 134 may be closer than the width of ridge waveguide 112.

Extensions 124 and 134 are in proximity to waveguide 112. For example, extensions 124 and 134 are a vertical distance, d from TFLC waveguide 116. The vertical distance to TFLC waveguide 116 may depend upon the cladding (not shown in FIG. 1B) used. The distance d is highly customizable in some cases. For example, d may range from zero (or less if electrodes 120 and 130 contact or are embedded in thin film portion 114) to greater than the height of ridge 112. However, d is generally still desired to be sufficiently small that electrodes 120 and 130 can apply the desired electric field to waveguide 112. Extensions 124 and 134 are also a distance, s, from ridge 112. Extensions 124 and 134 are desired to be sufficiently close to TFLC waveguide 116 (e.g. close to ridge 112) that the desired electric field and index of refraction change can be achieved. However, extensions 124 and 134 are desired to be sufficiently far from TFLC waveguide 116 (e.g. from ridge 112) that their presence does not result in undue optical losses. Although the distance s is generally agnostic to specific geometry or thickness of TFLC waveguide 116, s may be selected to allow for both transverse electric and transverse optical modes that are confined differently in TFLC waveguide 116. However, the optical field intensity at extensions 124 and 134 (and more particularly at sections 124B and 134B) is desired to be reduced to limit optical losses due to absorption of the optical field by the conductors in extensions 124 and 134. Thus, s and/or d are sufficiently large that the total optical loss for waveguide 112, including losses due to absorption at extensions 124 and 134, is not more than 10 dB or less in some embodiments, 1 dB or less in some embodiments, and/or 4 dB or less in some embodiments. In some embodiments, s is selected so that optical field intensity at extensions 124 and 134 is less than −10 dB of the maximum optical field intensity in waveguide 112. In some embodiments, s is chosen such that the optical field intensity at extensions 124 and 134 is less than −40 dB of its maximum value in the waveguide. For example, extensions 124 and/or 134 may be at least two micrometers and not more than 2.5 micrometers from ridge 112 in some embodiments. In some embodiments, extensions 124 and/or 134 may extend over waveguide 112 if d is greater than the height of the ridge for waveguide 112.

In the embodiment shown, extensions 124 have a connecting portion 124A and a retrograde portion 124B. Retrograde portion 124B is so named because a part of retrograde portion may be antiparallel to the direction of signal transmission through electrode 120. Similarly, extensions 134 have a connecting portion 1234A and a retrograde portion 134B. Thus, extensions 124 and 134 have a “T”-shape. In some embodiments, other shapes are possible. For example, extensions 124 and/or 134 may have an “L”-shape, may omit the retrograde portion, may be rectangular, trapezoidal, parallelogram-shaped, may partially or fully wrap around a portion of waveguide 112, and/or have another shape. Similarly, channel regions 122 and/or 132, which are shown as having a rectangular cross-section, may have another shape. Further, extensions 124 and/or 134 may be different sizes. Although all extensions 124 and 134 are shown as the same distance from ridge 112, some of extensions 124 and/or some of extensions 134 may be different distances from ridge 112. Channel regions 122 and/or 132 may also have a varying size. In some embodiments, extensions 124 and 134, respectively, are desired to have a length, 1 (e.g. 1 =w-s), that corresponds to a frequency less than the Bragg frequency of the signal for electrodes 120 and 130, respectively. Thus, the length of extensions 124 and 134 may be desired to be not more than the microwave wavelength of the electrode signal divided by x at the highest frequency of operation for electrodes 120 and 130. In some embodiments, the length of extensions 124 and 134 is desired to be less than the microwave wavelength divided by twelve. For example, if the maximum operation frequency is 300 GHz, which corresponds to a microwave wavelength of 440 micrometers in the substrate, extensions 124 and 134 are desired to be smaller than approximately 37 micrometers. Individual extensions 124 and/or 134 may be irregularly spaced or may be periodic. Periodic extensions have a constant pitch. In some embodiments, the pitch, p, is desired to be a distance corresponding to a frequency that is less than the Bragg frequency, as discussed above with respect to the length of extensions 124 and 134. Thus, the pitch for extensions 124 and 134 may be desired to be not more than the microwave wavelength of the electrode signal divided by x at the highest frequency of operation for electrodes 120 and 130. In some embodiments, the pitch is desired to be less than the microwave wavelength divided by twelve. In some embodiments, the pitch is desired to be less than the microwave wavelength divided by seventy two, allowing for a low ripple in group velocity.

Extensions 124 and 134 are closer to ridge 112 than channels 122 and 132, respectively, are (e.g. s <w). In some embodiments, a dielectric cladding (not explicitly shown in FIG. 1B) resides between electrodes 120 and 130 and TFLC waveguide 116. As discussed above, extensions 124 and 134 are desired to have a length (w-s) that corresponds to a frequency less than the Bragg frequency of the signal for electrodes 120 and 130, respectively. Extensions 124 and 134 are also desired to be spaced apart from ridge 112 as indicated above (e.g. such that the absorption loss in waveguide 112 can be maintained at the desired level, such as 10 dB or less). The length of the extensions 124 and 134 and desired separation from ridge 112 (e.g. s) are considered in determining w. Although described in the context of a horizontal distance, the distance between electrode structures and the waveguide also applies for vertical configurations. Other distances between ridge waveguide 112 and channel regions 122 and/or 132 are possible.

Extensions 124 and 134 protrude from channel regions 122 and 132, respectively, and reside between channel regions 122 and 132, respectively, and waveguide 110. As a result, extensions 124 and 134 are sufficiently close to waveguide 110 to provide an enhanced electric field at waveguide 110. Consequently, the change in index of refraction induced by the electric field is increased. In contrast, channel regions 122 and 132 are spaced further from waveguide 110 than the extensions 124 and 134. Thus, channel region 122 is less affected by the electric field generated by electrode 130/extensions 134. Electrical charges have a reduced tendency to cluster at the edge of channel region 122 closest to electrode 130. Consequently, current is more readily driven through central portions channel region 122 and the electrode losses in channel region 122 (and electrode 120) may be reduced. Because microwave signal losses through electrodes 120 and 130 may be reduced, a smaller driving voltage may be utilized for electrode(s) 120 and/or 130 and less power may be consumed by optical device 100. In addition, the ability to match the impedance of electrode 120 with an input voltage device (not shown) may be improved. Such an impedance matching may further reduce electrode signal losses for optical device 100. Moreover, extensions 124 and 134 may affect the speed of the electrode signal through electrodes 120 and 130. Thus, extensions 124 and 134 may be configured to adjust the velocity of the electrode signal to match the velocity of the optical signal in waveguide 110. Consequently, performance of optical device 100 may be improved.

Photonics device 100 may share the benefits of photonic devices described herein. Fabrication of photonics 100 may be simplified, made more repeatable and made more scalable. Thus, the benefits of TFLC photonics components may be combined with photodetection while achieving lower cost, higher yield, and/or improved scalability. The use of extensions 124 and 134 may improve performance. Use of electrodes 120 and 130 having extensions 124 and 134, respectively, may reduce microwave losses, allow for a large electric field at ridge waveguide 112 and improve the propagation of the microwave signal through electrodes 120 and 130, respectively. Further, the low surface roughness of the sidewalls of waveguide 112 may reduce optical losses. Consequently, performance of electro-optic device 110 may be significantly enhanced. However, in some embodiments, extensions 124 and/or 134 may be omitted.

Photonic device 100 (e.g., PIC 102/electro-optic modulator 110 in combination with multi-mode fiber(s) 140) may have improved performance. More specifically, high speed data communication (e.g. for distances not exceeding ten meters) may be provided simply and inexpensively. Photonics device 100 uses a single mode electro-optic modulator 110 that operates at shorter wavelengths (e.g. 800-1100 nanometers). Consequently, the length, L, of electro-optic modulator 110 may be reduced. The distances between electrodes 120 and 130 and 130 and 135 may also be reduced. Thus, a lower voltage may be used to drive electrodes. In some embodiments, optical modulator 110 may be used in a driverless configuration. PIC 102 may use single-ended, differential drive or binary weighted configurations for driving electrode 120, 130, and/or 140. For example, the V-pi-L of modulator 110 may be 0.6V cm in a single-ended push-pull configuration. This may support a 0.5V peak-to-peak differential drive for length, L, of approximately three millimeters. The shorter electronics can allow modulator 110 to maintain frequences of greater than 100 GHz or greater than 200 GHz for the electro-optic bandwidth.

Further, optical modulator 110 may support single spatial mode and single mode waveguide 116. This may also allow for high speeds to be achieved. A single mode modulator can achieve higher speeds and, in some embodiments, higher voltage, than a multi-mode optical modulator because single mode modulators are easier to control and modulate. For multi-mode modulators at high frequencies, velocity matching between the optical and microwave (electrode) signals to different modes can be difficult. Further, different optical modes may have different parameters for optimization. It may be difficult to control and optimize optical modulator 110 for different modes simultaneously, particularly for high speed applications. Thus, use of single mode modulator 110 may facilitate design and fabrication of photonics device 110/100. Using PIC 102, instead of coupling a modulated laser (not shown) to muti-mode fiber 140 may allow for high speed data communication because PIC 102 provides faster modulation than can be achieved by modulating the power input to the laser. Thus, photonics device 100 may facilitate high speed data communication.

While it was previously believed to be inefficient to use single mode PIC 102 with multi-mode fiber 140, the material properties of TFLC combat the inefficiency and provide modulation benefits. Single mode optical modulators are typically more expensive than VCSELs and use in data communications was considered inefficient. However, at shorter wavelengths and higher speeds, TFLC may provide large enough benefits in speed and power consumption to overcome the believed inefficiencies. TFLC may also be used as a universal platform for all distances and wavelengths, which may decrease costs. Moreover, TFLC PIC 102 is cost-efficient and faster than using bulk LN and/or LT. TFLC allows for simpler velocity matching between optical and microwave signals compared to bulk LN. In TFLC, microwave signal velocity may be controlled by controlling the substrate. In bulk LN, the substrate is the same material (LN), therefore there is one less degree of freedom. Thus, TFLC modulator 110 may have improved velocity matching.

In addition, use of multi-mode fiber(s) 140 may facilitate alignment of fibers 140 with waveguide 116. Multi-mode fibers 140 have a larger diameter (e.g. 50 millimeters) than single mode fibers (e.g. 10 millimeters). As a result, a larger output mode may be used for waveguide 116 and alignment between the output mode and multi-mode fiber 140 may be simplified. This may further decrease the cost of photonics device 100. Thus, for the above reason(s), single mode TFLC optical modulator 110 may improve data communications.

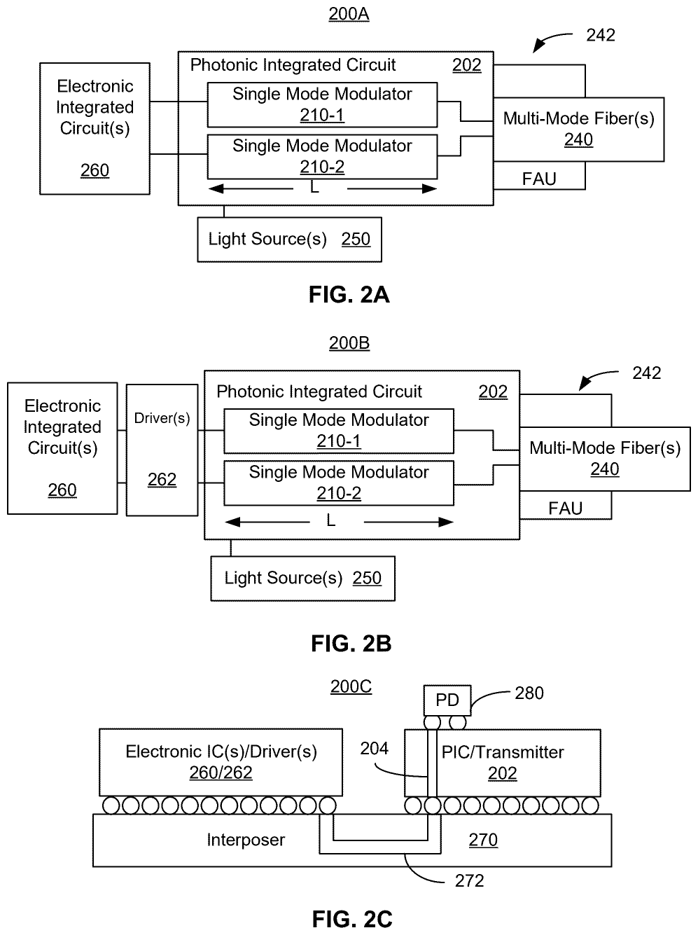

FIGS. 2A-2C depict embodiments of photonics devices 200A, 200B, and 200C capable of using shorter wavelengths and that are usable with multimode fibers. FIGS. 2A and 2B are block diagrams of photonic devices 200A and 200B. FIG. 2C depicts a side view of photonic device 200C.

Referring to FIG. 2A, photonics device 200A includes PIC 202, multi-mode fiber(s) 240, fiber attach unit (FAU) 242, light source 250, and electronic integrated circuit(s) (electronic IC(s)) 260. PIC 202 includes single mode optical modulators 210-1 and 210-2 (collectively or generically optical modulator(s) 210) that are analogous to optical modulators 110. Thus, optical modulators 210 may use shorter wavelengths, are single mode, and may utilize TFLC waveguides analogous to those described for photonics device 100. Although two optical modulators 210 are shown, another number may be present. In some embodiments, optical modulators 210 may be spaced to have a pitch of less than 300 micrometers. In some embodiment, the optical modulators 210 may be spaced to have a pitch of less than 250 micrometers. In some embodiment, optical modulators 210 may be spaced to have a pitch of less than 200 micrometers. The benefit of having optical modulators 210 closer together can be higher bandwidth per shoreline distance (e.g. length of electronic IC 260 from which output is provided).

Electronic IC 260 provides output high speed data signals that are desired to be carried over short distances consistent with data communication (e.g. not more than ten meters). Thus, optical communications are desired and multi-mode optical fiber(s) 240 may be used for transmission over such distances. FAU 242 is configured to be coupled with the multimode fiber(s) 240 and may facilitate alignment of fibers 240 with waveguides corresponding to optical modulators 210.

Light source 250 provides light that is encoded using electrodes (not explicitly shown in FIG. 2A) in optical modulators 210. In some embodiments, light source 250 is a VCSEL. A VCSEL may be used to provide shorter wavelength light (e.g. 800-1100 nanometers) used in optical modulators 210. In some embodiments, VCSEL 250 does not modulate the light. Instead, optical modulators 210 modulate the light from VCSEL 250. However, in some embodiments, both VCSEL 250 and the optical modulators 210 may modulate the light. In some embodiments, light source 250 is another type of laser other than a VCSEL

In some embodiments, electronic IC 260 may include an internal driver. However, in some embodiments, electronic IC 260 may not include a driver. For example, electronic IC 260 may be a digital IC (such as a DSP, SerDes, Retimer, or compute chips), without an external electronic driver. In some embodiments, the output voltage of electronic IC 260 is less than 2V peak-to-peak. In some embodiment, the output voltage of electronic IC 260 is less than 1.5V peak-to-peak. In some embodiment, the output voltage of electronic IC 260 is less than 1V peak-to-peak. In such embodiments, photonics device 200A may be a driverless device. Driving electrodes of optical modulators 210 using the data signal(s) from electronic IC 260 may be facilitated by the low voltages possible for TFLC modulators utilizing short wavelengths. Stated differently, the electrodes of optical modulators 210 may be driven using the output voltage (e.g. 2V peak-to-peak, 1.5 V peak-to-peak, or 1 V peak-to-peak),

Photonics device 200A may share the benefits of photonics device 100. Optical modulators 210 may be single mode, TFLC modulators that use shorter wavelengths. Optical modulators 210 may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators 210 may allow for a higher bandwidth output per shoreline distance of electronic IC 260. Using photonics device 200A, high speed data communication may be provided simply and inexpensively.

Referring to FIG. 2B, photonics device 200B includes PIC 202, multi-mode fiber(s) 240, FAU 242, light source 250, electronic IC 260 (s), and driver 262. PIC 202, multi-mode fiber(s) 240, FAU 242, light source 250, and electronic IC(s) 260 of photonics device 200B are analogous to PIC 202, multi-mode fiber(s) 240, FAU 242, light source 250, and electronic IC 260 of photonics device 200A. PIC 202 includes single mode optical modulators 210-1 and 210-2 (collectively or generically optical modulator(s) 210) that are analogous to optical modulators 110 and 210 of photonics devices 100 and 200A. Thus, optical modulators 210 may use shorter wavelengths, are single mode, and may utilize TFLCL waveguides analogous to those described for photonics device 100.

Photonics device 200B is analogous to and shares the benefits of photonics device 200A. In addition, a driver 262 is explicitly provided. In some embodiments, driver 262 may be incorporated into electronic IC 260.

Photonics device 200B may share the benefits of photonics device(s) 100 and 200A. Optical modulators 210 may be single mode, TFLC modulators that use shorter wavelengths. Optical modulators 210 may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators 210 may allow for a higher bandwidth output per shoreline distance of electronic IC 260. Using photonics device 200B, high speed data communication may be provided simply and inexpensively.

Referring to FIG. 2C, photonics device 200C includes PIC 202, electronic IC 260/262 (IC 260 may optionally include a driver 262), interposer 270, and photodiode 280. For simplicity, components such as multi-mode fibers 240, FAU 242 and light source 250 are not shown. PIC 202 and electronic IC 260/262 of photonics device 200B are analogous to PIC 202 and electronic IC 260/driver 262 of photonics device(s) 200A and/or 200B. PIC 202 includes single mode optical modulators (not explicitly shown) that are analogous to optical modulators 110 and 210 of photonics device(s) 100, 200A, and 200B. Thus, optical modulators 210 may use shorter wavelengths, are single mode, and may utilize TFLC waveguides analogous to those described for photonics device 100.

Photonics device 200C is analogous to and shares the benefits of photonics device(s) 200A and 200B. Electronic IC 260/262 and PIC 202 are integrated using interposer 270. Interposer 270 may be a silicon interposer, an organic printed circuit board, a high speed ceramic circuit board or other analogous components. In some embodiments, integration may take place in another manner. Also shown is photodiode 280 that may be used to monitor PIC 202. Further, vias, such as through-silicon via (TSV) 204 may be used to provide electrical connection to metallization 272 of interposer 270. In some embodiments, through-glass-vias (TGV) may also be used. Although not shown, a receiver (e.g. a multi-mode receiver) may be integrated with PIC 202 and electronic IC 260/262. Thus, PIC 202 may be co-packaged with electronics IC 260/262, on a common substrate.

Photonics device 200C may share the benefits of photonics device(s) 100, 200A, and 200B. Optical modulators may be single mode, TFLC modulators that use shorter wavelengths. Optical modulators may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators may allow for a higher bandwidth output per shoreline distance of electronic IC 260/262. Using photonics device 200C, high speed data communication may be provided simply and inexpensively.

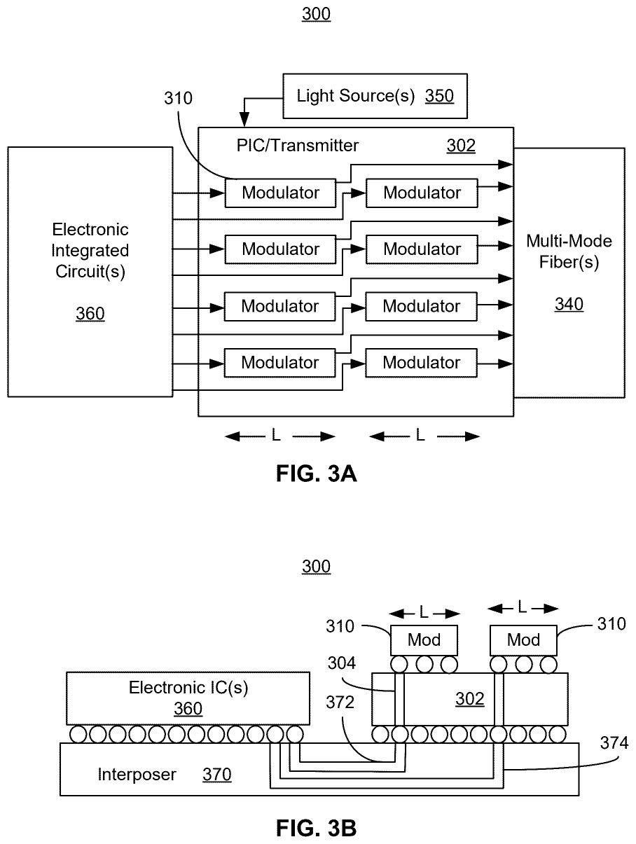

FIGS. 3A-3B depict an embodiment of photonics device 300 capable of using shorter wavelengths and that is usable with multimode fibers. FIG. 3A is a block diagram of photonic device 300. FIG. 3B depicts a side view of photonic device 300.

Referring to FIG. 3A, photonics device 300A includes PIC 302, multi-mode fiber(s) 340, light source 350, and electronic IC(s) 360. PIC 302 includes single mode optical modulators 310 (of which only some are labeled) that are analogous to optical modulators 110.

Thus, optical modulators 310 may use shorter wavelengths, are single mode, and may utilize TFLC waveguides analogous to those described for photonics device 100. Although eight optical modulators 310 are shown, another number may be present. In some embodiments, optical modulators 310 may be spaced to have a pitch of less than 300 micrometers. In some embodiment, the optical modulators 310 may be spaced to have a pitch of less than 350 micrometers. In some embodiment, optical modulators 310 may be spaced to have a pitch of less than 300 micrometers. The benefit of having optical modulators 310 closer together can be higher bandwidth per shoreline distance (e.g. length of electronic IC 360 from which output is provided). In addition, optical modulators 310 may be short (e.g. L may not exceed 1.5 or 1 centimeter). Consequently, optical modulators 310 may be arranged in an array.

In some embodiments, electronic IC 360 may include a driver analogous to driver 262. In some embodiments, a separate driver analogous to driver 260 may be provided. In other embodiments, photonics device 300 may be driverless. In the embodiments shown, optical modulators 310 may be separately fabricated and integrated on PIC 302. Electrical connection may be made to modulators 310 (e.g. to electrodes) via TSVs 304 and metallization 372 and 374 of interposer 370. In some embodiments, electronics IC 360, PIC 302, and modulators 310 may be integrated in another manner.

Photonics device 200 may share the benefits of photonics device(s) 100, 200A, 200B, and 200C. Optical modulators may be single mode, TFLC modulators that use shorter wavelengths. Optical modulators may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators may allow for a higher bandwidth output per shoreline distance of electronic IC 360. Using photonics device 300, high speed data communication may be provided simply and inexpensively.

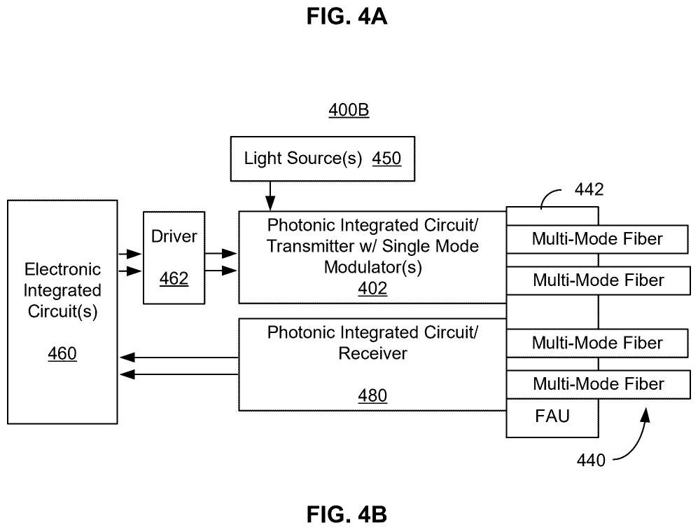

FIGS. 4A-4B depict embodiments of photonics devices 400A and 400B capable of using shorter wavelengths and that are usable with multimode fibers. FIG. 4A is a block diagram of photonic device 400A. FIG. 4B is a block diagram of photonic device 400B.

Referring to FIG. 4A, photonics device 400A includes PIC transmitter 402, multi-mode fiber(s) 440, FAU 442, light source 450, electronic IC(s) 460, and PIC receiver 480. Thus, photonics device 400A is a transceiver. PIC transmitter 402 includes single mode optical modulators that are analogous to optical modulators 110, 210, and/or 310. Thus, PIC transmitter 402 includes optical modulators that may use shorter wavelengths, are single mode, and may utilize TFLC waveguides analogous to those described for photonics device 100, 200A, 200B, 200C, and/or 300.

Electronic IC 460 is analogous to electronic ICs 260 and/or 360. Electronic IC 460 provides output high speed data signals that are desired to be carried over short distances consistent with data communication (e.g. not more than ten meters). Electronic IC also receives data. Thus, optical communications are desired and multi-mode optical fiber(s) 440 may be used for transmission over such distances. FAU 442 is configured to be coupled with the multimode fiber(s) 440 and may facilitate alignment of fibers 440 with waveguides corresponding to PIC transmitter 402 and PIC receiver 480. PIC receiver 480 is a multi-mode receiver.

Light source 450 provides light that is encoded using electrodes (not explicitly shown in FIG. 4A) in optical modulators of PIC transmitter 402. Light source 450 is analogous to light sources 250 and 350.

In some embodiments, electronic IC 460 may include an internal driver. However, in some embodiments, electronic IC 460 may not include a driver. In such embodiments, photonics device 400A may be a driverless device. Driving electrodes of optical modulators of PIC transmitter 402 using the data signal(s) from electronic IC 460 may be facilitated by the low voltages possible for TFLC modulators utilizing short wavelengths. Stated differently, the electrodes of optical modulators may be driven using the output voltage (e.g. 2V peak-to-peak, 1.5 V peak-to-peak, or 1 V peak-to-peak),

Photonics device 400A may share the benefits of photonics devices 100, 200A, 200B, 200C, and 300. Optical modulators may be single mode, TFLC modulators that use shorter wavelengths. Optical modulators may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators may allow for a higher bandwidth output per shoreline distance of electronic IC 460. Using photonics device 400A, high speed data communication may be provided simply and inexpensively.

Referring to FIG. 4B, photonics device 400B includes PIC transmitter 402, multi-mode fiber(s) 440, FAU 442, light source 450, electronic IC(s) 460, driver 462, and PIC receiver 480. Thus, photonics device 400B is a transceiver. PIC transmitter 402 includes single mode optical modulators that are analogous to optical modulators 110, 210, and/or 310. Thus, PIC transmitter 402 includes optical modulators that may use shorter wavelengths, are single mode, and may utilize TFLC waveguides analogous to those described for photonics device 100, 200A, 200B, 200C, and/or 300.

Electronic IC 460 is analogous to electronic ICs 260, 360, and/or 460. However, a separate driver 462 is explicitly shown. In some embodiments, driver 462 may be incorporated into electronics IC 460. Electronic IC 460 provides output high speed data signals that are desired to be carried over short distances consistent with data communication (e.g. not more than ten meters). Electronic IC also receives data. Thus, optical communications are desired and multi-mode optical fiber(s) 440 may be used for transmission over such distances. FAU 442 is configured to be coupled with the multimode fiber(s) 440 and may facilitate alignment of fibers 440 with waveguides corresponding to PIC transmitter 402 and PIC receiver 480. PIC receiver 480 is a multi-mode receiver. Light source 450 provides light that is encoded using electrodes (not explicitly shown in FIG. 4B) in optical modulators of PIC transmitter 402. Light source 450 is analogous to light sources 250 and 350.

Photonics device 400B may share the benefits of photonics devices 100, 200A, 200B, 200C, 300, and 400A. Optical modulators may be single mode, TFLC modulators that use shorter wavelengths. Optical modulators may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators may allow for a higher bandwidth output per shoreline distance of electronic IC(s) 460. Using photonics device 400B, high speed data communication may be provided simply and inexpensively.

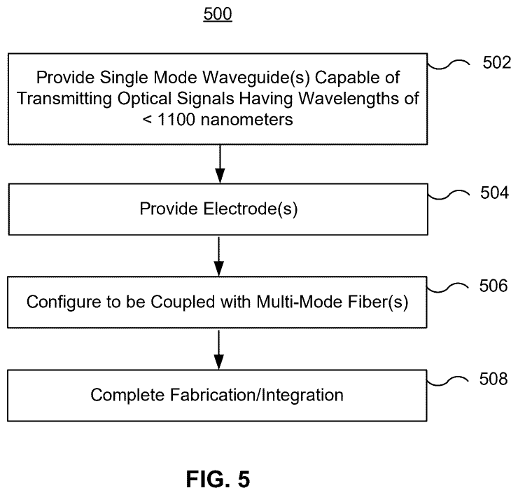

FIG. 5 is a flow chart depicting an embodiment of method 500 for providing a photonics device capable of using shorter wavelengths and that is usable with multimode fibers. Method 500 is described in the context of processes that may have sub-processes. Although described in a particular order, another order not inconsistent with the description herein may be utilized. Further, some processes may be performed in parallel and/or interleaved with portions of other processes.

A waveguide configured to transmit an optical signal having a wavelength less than 1100 nanometers is provided, at 502. The waveguide is a single mode waveguide and includes at least one electro-optic material. In some embodiments, 502 includes performing one or more etches on a TFLC layer residing on a substrate.

Electrodes are provided at 504. In some embodiments, at least a portion of the waveguide has been covered in cladding and/or other processes may be performed. 504 may include providing the electrodes via photolithography. The photonics device is configured to be coupled with multimode fiber(s), at 506. For example, a facet of a PIC including the waveguide and electrodes may be prepared for edge or vertical coupling to multi-mode fiber(s). Fabrication and/or integration of the photonics device may then be completed for example, a PIC including the waveguide and electrodes may be mounted on an interposer or otherwise integrated with an electronics IC.

For example, at 502, waveguide 116 may be provided. At 504, electrodes 120, 130, and 135 may be provided. At 506, PIC 102 may be prepared for coupling with multi-mode fiber(s) 140. At 508, fabrication of PIC 102 may be completed. Further, PIC 102 may be integrated with electronic IC(s), such as electronic IC(s) 260. For example, PIC 102 and electronic IC(s) 260 may be mounted on interposer 270.

Thus, using method 500, the benefits of photonics devices 100, 200A, 200B, 200C, 300, 400A, and 400B may be improved. Optical modulators may be single mode, TFLC modulators that use shorter wavelengths. Optical modulators may also have shorter lengths (e.g. not more than one centimeter), a large electro-optic bandwidth (e.g. at least 100 GHz or at least 200 GHz), and a low input voltage (e.g. not more than 2V). Further, a closer spacing of optical modulators may allow for a higher bandwidth output per shoreline distance of electronic IC(s). Thus, high speed data communication may be provided simply and inexpensively.

Although the foregoing embodiments have been described in some detail for purposes of clarity of understanding, the invention is not limited to the details provided. There are many alternative ways of implementing the invention. The disclosed embodiments are illustrative and not restrictive.

1. A photonics device, comprising:
a waveguide configured to transmit an optical signal having a wavelength less than 1100 nanometers and being a single mode waveguide, the waveguide includes at least one electro-optic material; and
an electrode proximate to a portion of the waveguide and configured to carry an electrode signal for modulating the optical signal;
wherein the photonics device is configured to be coupled with at least one multimode fiber, the at least one multimode fiber configured to transmit a plurality of modes.

2. The photonics device of claim 1, wherein the electrode is driven by a data signal received at the photonics device.

3. The photonics device of claim 1, wherein the electro-optic material includes lithium.

4. The photonics device of claim 1, further comprising:
an additional electrode proximate to the portion of the waveguide, the portion of the waveguide being between the additional electrode and the electrode, the electrode and the additional electrode being separated by a distance of not more than three micrometers proximate to the portion of the waveguide.

5. The photonics device of claim 1, further comprising:
a fiber array unit, the fiber array unit being configured to be coupled with the at least one multimode fiber.

6. The photonics device of claim 1, wherein the optical signal includes light having the wavelength received from a vertical cavity surface emitting laser (VCSEL).

7. The photonics device of claim 1, further comprising:
a multi-mode receiver.

8. The photonics device of claim 1, wherein the portion of the waveguide proximate to the electrodes has a length of not more than one centimeter, an electro-optic bandwidth of at least 100 GHz, and an input voltage for the electrode of not more than 2 V.

9. A photonics device, comprising:
an optical transmitter including a plurality of waveguides and a plurality of electrodes, the plurality of waveguides being configured to transmit optical signals and being single mode waveguides, the plurality of waveguides including at least one electro-optic material, a waveguide of the plurality of waveguides carrying an optical signal of the optical signals, the optical signal having a wavelength less than 1100 nanometers, a portion of the plurality of electrodes being proximate to a portion of each of the plurality of waveguides, the plurality of electrodes being configured to carry electrode signals for modulating the optical signals; and
a receiver configured to received input optical signals;
wherein the photonics device is configured to be coupled with a plurality of multimode fibers, each of the plurality of multimode fibers being configured to transmit a plurality of modes.

10. The photonics device of claim 9, wherein the plurality of electrodes is driven by a plurality of data signals received at the photonics device.

11. The photonics device of claim 9, wherein the electro-optic material includes lithium.

12. The photonics device of claim 9, wherein the plurality of electrodes includes a first electrode and a second electrode, the portion of a waveguide of the plurality of waveguides being between the first electrode and the second electrode, the first electrode and the second electrode being separated by a distance of not more than three micrometers proximate to the portion of the waveguide.

13. The photonics device of claim 9, further comprising:
a fiber array unit, the fiber array unit being configured to be coupled with the plurality of multimode fibers.

14. The photonics device of claim 9, wherein the plurality of optical signals include light received from a vertical cavity surface emitting laser (VCSEL).

15. The photonics device of claim 9, further comprising:
an interposer configured to couple the receiver, the transmitter, and an electronics integrated circuit.

16. The photonics device of claim 9, wherein the portion of each of the plurality of waveguides proximate to the portion of the plurality of electrodes has a length of not more than one centimeter, an electro-optic bandwidth of at least 100 GHz, and an input voltage for the electrode of not more than 2 V.

17. A method for providing a photonics device, comprising:
providing a waveguide configured to transmit an optical signal having a wavelength less than 1100 nanometers and being a single mode waveguide, the waveguide includes at least one electro-optic material; and
providing an electrode proximate to a portion of the waveguide and configured to carry an electrode signal for modulating the optical signal;
wherein the photonics device is configured to be coupled with at least one multimode fiber, the at least one multimode fiber configured to transmit a plurality of modes.

18. The method of claim 17, wherein the electro-optic material includes lithium.

19. The method of claim 17, wherein the providing the electrode further includes: providing an additional electrode proximate to the portion of the waveguide, the portion of the waveguide being between the additional electrode and the electrode, the electrode and the additional electrode being separated by a distance of not more than three micrometers proximate to the portion of the waveguide.

20. The method of claim 17, wherein the portion of the waveguide proximate to the electrodes has a length of not more than one centimeter, an electro-optic bandwidth of at least 100 GHz, and an input voltage for the electrode of not more than 2 V.
